(19) United States
(12) Patent Application Publication
(10) Pub. No.: US 2014/0307624 A1
(43) Pub. Date: Oct. 16, 2014

(54) METHOD AND APPARATUS FOR SCHEDULING VIDEO TRAFFIC IN WIRELESS COMMUNICATION SYSTEM

(71) Applicant: Samsung Electronics Co., Ltd., Gyeonggi-do (KR)

(72) Inventors: Min Kim, Seoul (KR); Yong-Seok Park, Seoul (KR); Chul-Ki Lee, Seoul (KR)

(73) Assignee: Samsung Electronics Co., Ltd., Gyeonggi-do (KR)

(21) Appl. No.: 14/253,829

(22) Filed: Apr. 15, 2014

(30) Foreign Application Priority Data
Apr. 15, 2013 (KR) 10-2013-0040982

(51) Int. Cl. H04L 12/863; H04N 21/61

(52) U.S. Cl. CPC H04L 47/6215; H04N 21/6131
USPC 370/328

(57) ABSTRACT

A method of scheduling video traffic in a wireless communication system includes detecting codec information and a number of video frames included in at least one video traffic. The method also includes predicting a reproduction time of the at least one video traffic by using the codec information and the number of video frames. The method also includes performing scheduling of the at least one video traffic based on the predicted reproduction time.

### CROSS-REFERENCE TO RELATED APPLICATION(S) AND CLAIM OF PRIORITY

The present application is related to and claims priority under 35 U.S.C. §119(a) to Korean Application Serial No. 10-2013-0040982, which was filed in the Korean Intellectual Property Office on Apr. 15, 2013, the entire content of which is hereby incorporated by reference.

### TECHNICAL FIELD

The present disclosure relates to a method and an apparatus for scheduling video traffic in a wireless communication system.

### BACKGROUND

A conventional wireless communication system mainly considered a size of a buffer allocated at video traffic to calculate a scheduling priority of the video traffic. Specifically, the conventional wireless communication system allocated a buffer at every video traffic transmitted by a base station and performed scheduling such that packets remaining in each buffer are identified and then a highest priority is assigned to video traffic having largest packets.

A method of calculating a priority based on packets remaining in the buffer does not consider a characteristic of the video traffic, and thus cannot accurately predict a reproduction time of the video traffic. It is because packets associated with the reproduction at the same time vary depending on a video format, a codec, and a resolution used for the video traffic. For example, in a situation of a video using a moving picture experts group (MPEG) codec, video packets associated with the reproduction at the same time when the resolution is reduced to ½ are reduced to ¼.

Accordingly, the conventional art uses a method of accurately predicting a time at which a terminal may reproduce video traffic in consideration of a characteristic of the video traffic and performing scheduling of the video traffic based on a result of the prediction.

### SUMMARY

To address the above-discussed deficiencies, it is a primary object to provide a method and an apparatus for scheduling video traffic in a wireless communication system.

The present disclosure provides a method and an apparatus in which a base station figures out a characteristic of video traffic and accurately predicts a time for which a terminal can reproduce the corresponding video.

The present disclosure provides a method and an apparatus for predicting a time for which a terminal can reproduce a video at every scheduling time to determine a priority and scheduling video traffic based on the determined priority in a wireless communication system of scheduling video traffic and transmitting the scheduled video traffic to a plurality of users according to a priority.

In accordance with an aspect of the present disclosure, an embodiment provides a method of scheduling video traffic in a wireless communication system. The method includes detecting codec information and a number of video frames included in at least one video traffic. The method also includes predicting a reproduction time of the at least one video traffic by using the codec information and the number of video frames. The method also includes performing scheduling of the at least one video traffic based on the predicted reproduction time.

In accordance with another aspect of the present disclosure, an embodiment provides an apparatus for scheduling video traffic in a wireless communication system. The apparatus includes a radio unit configured to receive at least one video traffic. The apparatus also provides a scheduler configured to detect codec information and a number of video frames included in the at least one video traffic. The scheduler is further configured to predict a reproduction time of the at least one video traffic by using the codec information and the number of video frames. The scheduler is further configured to perform scheduling of the at least one video traffic based on the predicted reproduction time.

The present disclosure has an effect of providing a seamless video service to a user through scheduling achieved by predicting a video traffic reproduction time (or remaining buffering time) of each video traffic in a mobile terminal which is receiving the video traffic and assigning a highest priority to a terminal receiving video traffic having a shortest predicted reproduction time.

Further, the present disclosure has an effect of saving uplink resources and not influencing an entire system capability since information obtained by a base station is used for predicting a reproduction time of video traffic without a request for related feedback such as a buffer size to a mobile terminal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a base station in a wireless communication system according to an embodiment of the present disclosure;

FIG. 2 illustrates a process of performing video traffic scheduling based on a predicted reproduction time according to an embodiment of the present disclosure;

FIG. 3 illustrates a process of predicting a reproduction time of video traffic according to an embodiment of the present disclosure; and

FIG. 4 illustrates a process of performing video traffic scheduling based on a remaining buffering time according to an embodiment of the present disclosure.

### DETAILED DESCRIPTION

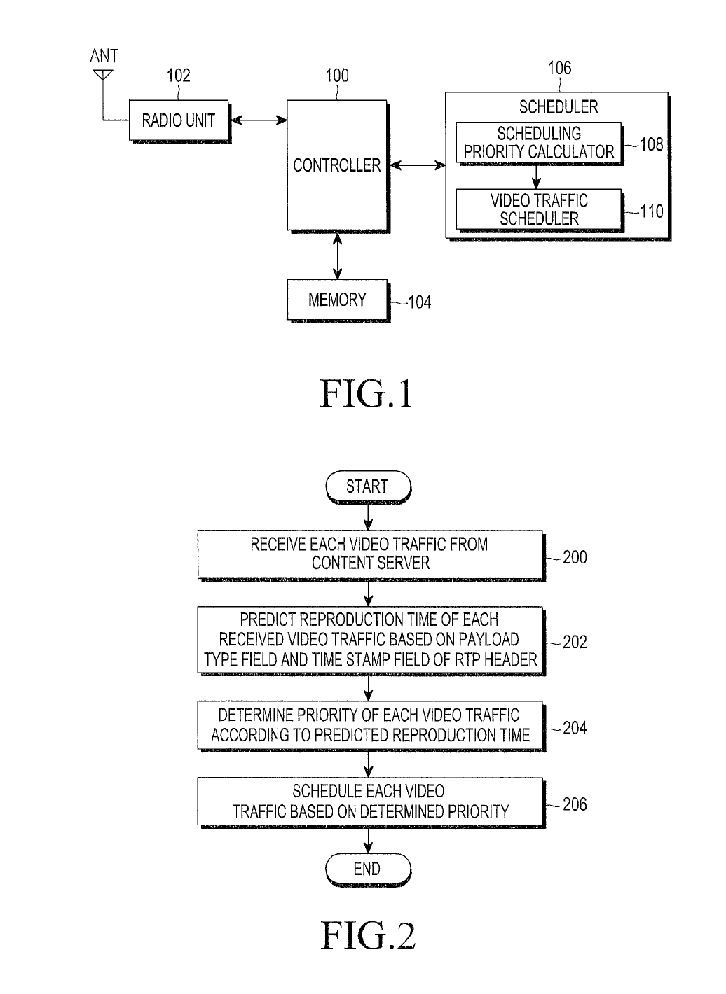

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or method. Hereinafter, an operation principle of the present disclosure will be described in detail with reference to the accompanying drawings. A detailed description of known functions and configurations incorporated herein will be omitted as it may make the subject matter of the present disclosure rather unclear. Further, terms described later are defined in consideration of the functions of the present disclosure, but may vary according to the intention or convention of a user or operator. Therefore, the definitions may be determined based on the overall contents of the present specification.

Embodiments of the present disclosure provide a method and an apparatus for scheduling video traffic in a wireless communication system. A video traffic scheduling apparatus according to an embodiment of the present disclosure detects codec information based on a payload type field of a real-time applications protocol (RTP) header included in at least one video traffic, determines a frame rate based on the detected codec information, counts a number of video frames included in the at least one video traffic, predicts a reproduction time of the at least one video traffic by using the frame rate and the number of video frames, and performs scheduling of the at least one video traffic based on the predicted reproduction time.

Hereinafter, an example in which the video traffic scheduling apparatus corresponds to a base station and a video traffic receiving apparatus corresponds to a mobile terminal will be described. However, the video traffic scheduling apparatus and the video traffic receiving apparatus are not limited to the base station and the mobile terminal and may be variously changed.

FIG. 1 illustrates a block diagram of a base station in a wireless communication system according to an embodiment of the present disclosure.

Referring to FIG. 1, the base station includes a controller 100, a radio unit 102, a memory 104, and a scheduler 106.

The controller 100 controls the radio unit 102, the memory 104, and the scheduler 106, and controls general operations of the base station. The radio unit 102 is a component for performing wireless communication with the mobile terminal and, for example, transmits the video traffic to the mobile terminal. The memory 104 stores various pieces of information generated according to the operations of the base station (for example, information of the mobile terminal and scheduling information).

The scheduler 106 is a component for determining a scheduling priority of the video traffic and includes a scheduling priority calculator 108 and a video traffic scheduler 110. The scheduling priority calculator 108 analyzes packets of video traffic received from an external server (for example, content server) and calculates a scheduling priority based on a result of the analysis. Further, the video traffic scheduler 101 determines transmission orders of all video traffics based on the calculated priority.

Although FIG. 1 illustrates that the scheduler 106 includes the scheduling priority calculator 108 and the video traffic scheduler 110, the scheduler 106 may be a single component that performs operations of both the scheduling priority calculator 108 and the video traffic scheduler 110. Further, although FIG. 1 illustrates that the scheduler 106 is a component physically separated from the controller 100, the operation of the scheduler 106 may be performed by the controller 100. In this embodiment, the scheduler 106 may be included in the controller 100 or may be omitted.

Hereinafter, it will be described that the video traffic scheduling method provided by an embodiment of the present disclosure is performed by the scheduler 106 for the convenience of description. The scheduler 106 may perform the video traffic scheduling method based on information included in an RTP header. The RTP header may be defined as, for example, Table 1 below.

TABLE 1

| Control bit | | | | | | |
|---|---|---|---|---|---|---|
| V | P | X | CC | M | Payload Type | Sequence Number |

Time Stamp
Synchronization Source Identifier (SSRC)
Contributor Source Identifier (CSRC)
. . .
Contributor Source Identifier (CSRC)

In Table 1, a control bit includes a version (V) field of 2 bits indicating a current RTP version, a padding (P) field of 1 bit indicating a padding bit used for configuring packets in the unit of 32 bits (when a value is set, it indicates that padding bits are included in a payload end part), an extension (X) field of 1 bit indicating an extension bit (when a value is set as 1, it indicates that a header is extended after a fixed header), a CSRC count (CC) field of 4 bits indicating a number of CSRC identifiers (IDs), and a maker (M) field of 1 bit used for expressing a boundary between frames in a packet stream (expresses an end of the frame in a video payload and a start of talk spurt in an audio payload).

A payload type field includes 7 bits and indicates audio and video encoding types. The payload type field may include at least one of an audio type number and a video type number. The payload type field indicates a PCM when the audio type number is 0, indicates 1016 when the audio type number is 1, indicates a GSM when the audio type number is 3, and indicates MPEG audio when the audio type number is 14. The payload type field indicates a JPEG video when the video type number is 26 and indicates an MPEG-2 video when the video type number is 32.

A sequence number field includes 16 bits and a value of the sequence number field increases by 1 whenever a packet is transmitted. Accordingly, the sequence number field may be used for detecting a packet error and a packet order. A time stamp field includes 32 bits, indicates a time relation between packets, and is used for data synchronization. An SSRC field includes 32 bits and is used for identifying sources of an RTP stream for each RTP session, and a CSRC field includes 32 bits and is used for identifying a single information stream.

Hereinafter, a process in which the scheduler 106 performs video traffic scheduling by using the RTP header will be described in detail with reference to FIG. 2.

FIG. 2 illustrates a process of performing video traffic scheduling based on a predicted reproduction time according to an embodiment of the present disclosure.

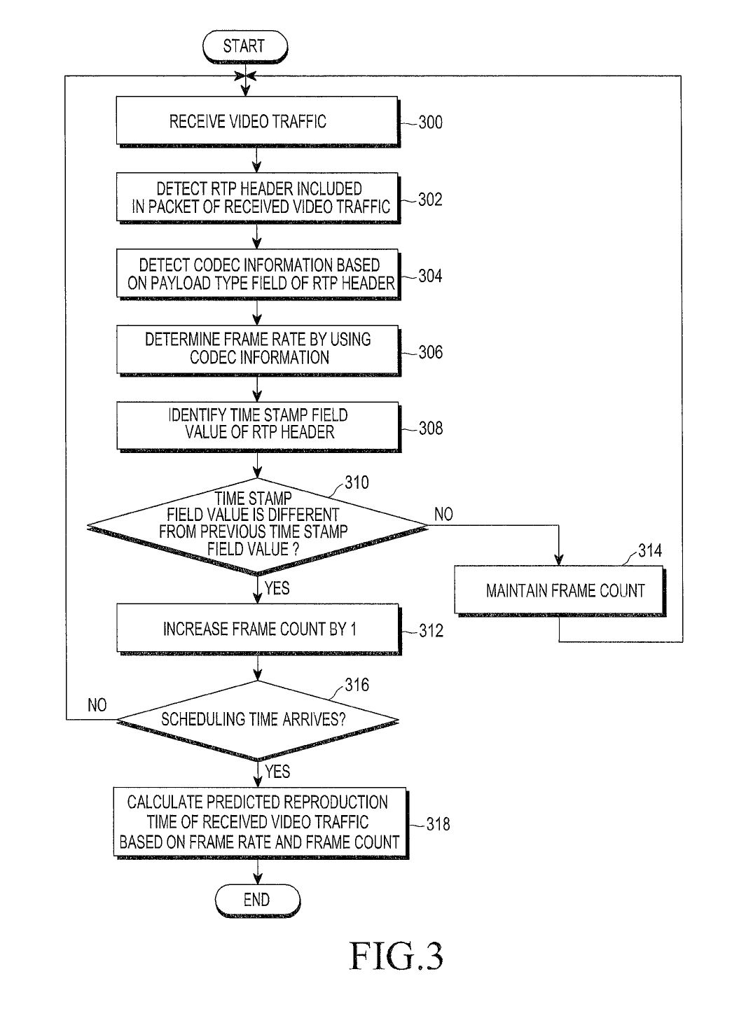

Referring to FIG. 2, the scheduler 106 receives video traffic for each content from a content server in operation 200. Further, the scheduler 106 predicts a reproduction time of each of the received video traffics based on the payload type field and the time stamp field of the RTP header in operation 202. A process of predicting the reproduction time of each video traffic will be described in detail with reference to FIG. 3 below.

The scheduler 106 determines a priority of each video traffic according to the predicted reproduction time in operation 204. For example, the scheduler 106 may determine the video traffic including a shortest reproduction time as the predicted reproduction time to include a highest priority or a lowest priority. When the priority is determined as described above, the scheduler 106 performs scheduling of each video traffic based on the determined priority.

Next, the process of predicting the reproduction time of each video traffic will be described with reference to FIG. 3.

FIG. 3 illustrates a process of predicting the reproduction time of the video traffic according to an embodiment of the present disclosure.

Referring to FIG. 3, the scheduler 106 receives video traffic in operation 300 and detects an RTP header included in a packet of the received video traffic in operation 302. Subsequently, the scheduler 106 determines codec information based on the payload type field of the RTP header in operation 304.

The scheduler 106 may determine the codec information based on a video type number or the like included in the payload type field. It is because a value of the payload type field varies depending on a type of codec used for the video traffic. For example, the scheduler 106 may determine MPEG-2 as the codec information when corresponding to the video type number is included in the payload type field.

The scheduler 106 determines a frame rate (a number of frames transmitted per second) by using the determined codec information in operation 306. Since the scheduler 106 may know a position of a codec header in the packet of the received video traffic when the codec information is determined, the scheduler 106 may determine the frame rate from the codec header.

Transmission of the video traffic is made in a form of transmission of a video frame in the unit of packets. When a size of one video frame is larger than a size of one packet, one video frame may be divided into a plurality of packets and then transmitted. In order to indicate that the plurality of packets is included in the same video frame, the same time stamp field value may be used for the plurality of packets.

In consideration of such matters, the scheduler 106 identifies a time stamp field value of the RTP header in operation 308. Further, the scheduler 106 determines whether the identified time stamp value is different from a previously identified time stamp value in operation 310. When the identified time stamp value is not different from the previously identified time stamp value, that is, when they are the same as each other, the scheduler 106 maintains a frame count without any change in operation 314. When the identified time stamp value is different from the previously identified time stamp value, the scheduler 106 increases the frame count by 1 in operation 312.

The scheduler 106 determines whether a video traffic scheduling time arrives in operation 316. When the video traffic scheduling time does not arrive, the scheduler 106 returns to operation 300 to receive the video traffic. When the video traffic scheduling time arrives, the scheduler 106 calculates a predicted reproduction time of the received video traffic based on the frame rate and the frame count in operation 318. The predicted reproduction time may be calculated by using, for example, equation (1) below.

Tb=Fc/Fr (1)

In equation (1) above, Tb denotes a predicted reproduction time of video traffic, Fc denotes a frame count, and Fr denotes a frame rate.

The above described process illustrated in FIG. 3 may be performed for each video traffic and the scheduler 106 may determine a priority based on a predicted reproduction time for each video traffic to perform the scheduling.

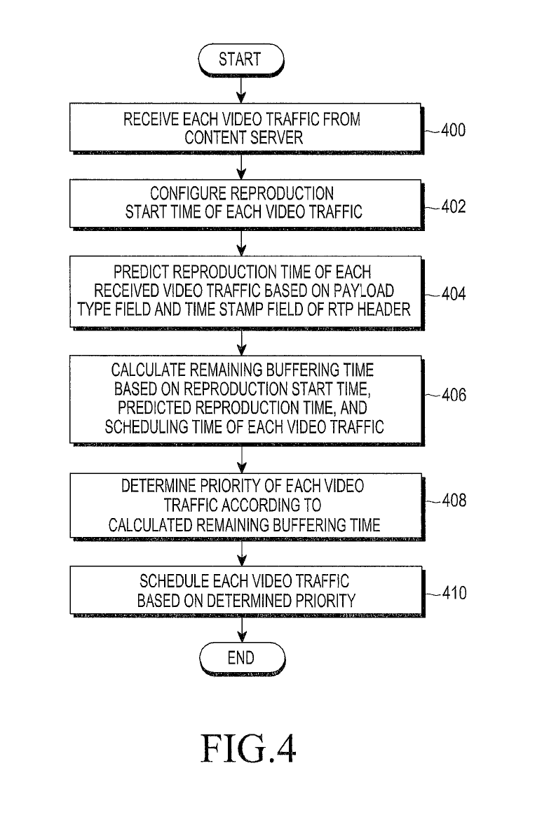

The video traffic scheduling may be performed based on the predicted reproduction time for each video traffic in the above described embodiment of the present disclosure, but the video traffic scheduling may be performed in consideration of a remaining buffering time in another method. A detailed description thereof will be described below with reference to FIG. 4.

FIG. 4 illustrates a process of performing video traffic scheduling based on the remaining buffering time according to an embodiment of the present disclosure.

Referring to FIG. 4, the scheduler 106 receives video traffic for each content from a content server in operation 400. Then, the scheduler 106 configures a reproduction start time of each video traffic in operation 402. For example, the scheduler 106 may configure the reproduction start time based on whether the video traffic received for each content is initially received video traffic.

Specifically, when the received video traffic is the initially received video traffic, the scheduler 106 may transmit the corresponding video traffic to the mobile terminal. Then, when the scheduler 106 receives a message including reproduction start information from the mobile terminal, the scheduler 106 may configure the reproduction start time based on the reproduction start information. Further, the scheduler 106 may configure a time at which the corresponding video traffic is initially transmitted to the mobile terminal as the reproduction start time. In addition, the scheduler 106 may configure a time at which the scheduler 106 receives a response message from the mobile terminal after transmitting the corresponding video traffic as the reproduction start time. When the received video traffic is not the initially received video traffic, the scheduler 106 may use a previously configured reproduction start time.

When the reproduction start time is configured as described above, the scheduler 106 predicts a reproduction time of each of the received video traffics based on the payload type field and the time stamp field of the RTP header in operation 404. Since the process of predicting the reproduction time of each video traffic has been described through FIG. 3, a detailed description thereof will be omitted.

The scheduler 106 calculates the remaining buffering time based on the reproduction start time, the predicted reproduction time, and the scheduling time of each video traffic in operation 406. For example, the scheduler 106 may calculate the remaining buffering time by using equation (2) below.

Tr=Tb−(Tn−Tp) (2)

In equation (2) above, Tr denotes a remaining buffering time, Tb denotes a predicted reproduction time, Tn denotes a current time at which the scheduling is being performed, and Tp denotes a reproduction start time.

When the remaining buffering time of each video traffic is calculated, the scheduler 106 determines a priority of each video traffic according to the calculated remaining buffering time in operation 408. For example, the scheduler 106 may determine the video traffic including a shortest buffering time as the remaining buffering time to include a highest priority or a lowest priority. When the priority is determined as described above, the scheduler 106 performs the scheduling of each video traffic based on the determined priority.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of scheduling video traffic in a wireless communication system, the method comprising:
detecting codec information and a number of video frames included in at least one video traffic;
predicting a reproduction time of the at least one video traffic by using the codec information and the number of video frames; and
performing scheduling of the at least one video traffic based on the predicted reproduction time.

2. The method of claim 1, wherein the codec information is detected based on a payload type field of a real-time applications protocol (RTP) header included in the at least one video traffic.

3. The method of claim 1, wherein the predicting of the reproduction time comprises:
determining a frame rate based on the codec information; and
predicting the reproduction time of the at least one video traffic by using the frame rate and the number of video frames.

4. The method of claim 1, wherein the performing of the scheduling of the at least one video traffic comprises configuring video traffic comprising a shortest time as the predicted reproduction time among the at least one video traffic to comprise a highest priority.

5. The method of claim 1, wherein the number of video frames is detected based on a time stamp field value of a real-time applications protocol (RTP) header included in the at least one video traffic.

6. The method of claim 1, further comprising:
if a reproduction start time of the at least one video traffic is obtained, determining a buffering time based on the reproduction start time, the predicted reproduction time, and a time at which the scheduling is performed; and
performing the scheduling of the at least one video traffic based on the buffering time.

7. The method of claim 6, wherein the determining of the buffering time comprises determining a time generated by subtracting a difference between the time at which the scheduling is performed and the reproduction start time from the predicted reproduction time as the buffering time.

8. The method of claim 6, wherein the performing of the scheduling of the at least one video traffic based on the buffering time comprises configuring video traffic comprising a shortest time as the buffering time among the at least one video traffic to comprise a highest priority.

9. The method of claim 6, wherein the reproduction start time of the at least one video traffic is obtained based on information on the reproduction start time of the at least one video traffic received from a video traffic receiving apparatus.

10. The method of claim 6, wherein the reproduction start time of the at least one video traffic is configured as a time at which the at least one video traffic is initially transmitted to a video traffic receiving apparatus.

11. An apparatus for scheduling video traffic in a wireless communication system, the apparatus comprising:
a radio unit configured to receive at least one video traffic; and
a scheduler configured to detect codec information and a number of video frames included in the at least one video traffic, predict a reproduction time of the at least one video traffic by using the codec information and the number of video frames, and perform scheduling of the at least one video traffic based on the predicted reproduction time.

12. The apparatus of claim 11, wherein the codec information is detected based on a payload type field of a real-time applications protocol (RTP) header included in the at least one video traffic.

13. The apparatus of claim 11, wherein the scheduler is further configured to determine a frame rate based on the codec information and predict the reproduction time of the at least one video traffic by using the frame rate and the number of video frames.

14. The apparatus of claim 11, wherein the scheduler is further configured to configure video traffic comprising a shortest time as the predicted reproduction time among the at least one video traffic to comprise a highest priority.

15. The apparatus of claim 11, wherein the number of video frames is detected based on a time stamp field value of a real-time applications protocol (RTP) header included in the at least one video traffic.

16. The apparatus of claim 11, wherein, after a reproduction start time of the at least one video traffic is obtained, the scheduler is further configured to determine a buffering time based on the reproduction start time, the predicted reproduction time, and a time at which the scheduling is performed and performs the scheduling of the at least one video traffic based on the buffering time.

17. The apparatus of claim 16, wherein the scheduler is further configured to determine a time generated by subtracting a difference between the time at which the scheduling is performed and the reproduction start time from the predicted reproduction time as the buffering time.

18. The apparatus of claim 16, wherein the scheduler is further configured to configure video traffic comprising a shortest time as the buffering time among the at least one video traffic to comprise a highest priority.

19. The apparatus of claim 16, wherein the reproduction start time of the at least one video traffic is obtained based on information on the reproduction start time of the at least one video traffic received from a video traffic receiving apparatus.

20. The apparatus of claim 16, wherein the reproduction start time of the at least one video traffic is configured as a time at which the at least one video traffic is initially transmitted to a video traffic receiving apparatus.
